(19) United States
(12) Patent Application Publication
(10) Pub. No.: US 2006/0067591 A1
(43) Pub. Date: Mar. 30, 2006

(54) Method and system for classifying image orientation

(76) Inventors: John Guzzwell, St. John's (CA); Edythe Patricia LeFeuvre, St. John's (CA); Rodney Hale, St. John's (CA); Douglas Pittman, Paradise (CA)

Correspondence Address: BERESKIN AND PARR, 40 KING STREET WEST, BOX 401, TORONTO, ON, M5H 3Y2, CA

(21) Appl. No.: 11/234,286

(22) Filed: Sep. 26, 2005

(30) Foreign Application Priority Data
Sep. 24, 2004 (CA) 2,479,664

(51) Int. Cl. G06K 9/36; G06K 9/46

(52) U.S. Cl. 382/289; 382/190

(57) ABSTRACT

The invention relates to a method, system and computer program product for identifying an orientation of an image having a plurality of features. It comprises (a) defining a plurality of feature kinds, wherein each feature in the plurality of features corresponds to an associated feature kind in the plurality of feature kinds; (b) providing a feature kind classification order for ordering the plurality of feature kinds; (c) searching the image to identify a feature set in the plurality of features in the image based on the feature kind classification order, wherein the feature set comprises at least one feature and each feature in the feature set corresponds to a defining feature kind; and (d) classifying the feature set to determine the orientation of the image.

### FIELD OF THE INVENTION

The invention relates generally to the field of image processing, and more specifically relates to a method and system for determining the orientation of images.

### BACKGROUND OF THE INVENTION

Digital cameras have gained a great deal of popularity, and as a result many different storage mediums are employed to store images taken from digital cameras. For example, such storage mediums may include CDs, DVDs, floppy disks, hard drives, flash memory cards, servers, or any other similar electronic storage mediums. Not only are these storage mediums used to store images taken by digital cameras, but they are also used to store images that were initially captured on a film roll and were then converted to a digital format (i.e. through scanning).

Images stored on these storage mediums may be viewed, printed, or used as input to software applications. As images are stored upon the storage mediums through various methods, including the scanning of the image using a scanner, when the images are viewed the image may not always be displayed such that they are in their preferred viewing orientation. The preferred viewing orientation is the orientation in which the image was captured. Most often, this orientation has the edge of the image which contains the lowest elevation objects in the image as the bottom edge of the image. As an example, with images that have captured natural scenery, such as the sky, people, and buildings, the preferred viewing orientation will have the sky at the top of the display, the ground at the bottom, and the people and buildings upright.

When these images are viewed by users, users are readily able to detect whether or not the images are in their preferred viewing orientation, and are able to make use of the controls that are provided to them to allow for them to rotate and orient this image correctly. These manual orientation methods are time consuming, and take sway from a user's enjoyment when viewing the images. As a result, automated methods of classifying the orientation of images have been developed. However, these automated classifying methods focus only on specific areas of an image in an attempt to determine the orientation, and as such, are prone to inaccurate results.

### SUMMARY OF THE INVENTION

In accordance with a first aspect of the invention, there is provided a method of identifying an orientation of an image having a plurality of features. The method comprises (a) defining a plurality of feature kinds, wherein each feature in the plurality of features corresponds to an associated feature kind in the plurality of feature kinds; (b) providing a feature kind classification order for ordering the plurality of feature kinds; (c) searching the image to identify a feature set in the plurality of features in the image based on the feature kind classification order, wherein the feature set comprises at least one feature and each feature in the feature set corresponds to a defining feature kind; and (d) classifying the feature set to determine the orientation of the image.

In accordance with a second aspect of the invention, there is provided a system of identifying an orientation of an image having a plurality of features. The system comprises a memory for storing (i) the image; and (ii) a plurality of feature kinds, wherein each feature in the plurality of features corresponds to an associated feature kind in the plurality of feature kinds. The system also comprises means for performing the steps of (a) accessing a feature kind classification order for ordering the plurality of feature kinds; (b) searching the image to identify a feature set in the plurality of features in the image based on the feature kind classification order, wherein the feature set comprises at least one feature and each feature in the feature set corresponds to a defining feature kind; and (c) classifying the feature set to determine the orientation of the image.

In accordance with a third aspect of the invention, there is provided a computer program product for use on a computer system to identifying an orientation of an image having a plurality of features. The computer program product comprises a recording medium for recording (i) a plurality of feature kinds, wherein each feature in the plurality of features corresponds to an associated feature kind in the plurality of feature kinds; and (ii) means for instructing the computer system to perform the steps of (a) accessing a feature kind classification order for ordering the plurality of feature kinds; (b) searching the image to identify a feature set in the plurality of features in the image based on the feature kind classification order, wherein the feature set comprises at least one feature and each feature in the feature set corresponds to a defining feature kind; and (c) classifying the feature set to determine the orientation of the image.

### BRIEF DESCRIPTION OF THE DRAWINGS

For a better understanding of the invention and to show more clearly how it may be carried into effect, reference will now be made by way of example only, to the accompanying drawings which show at least one exemplary embodiment of the invention and in which:

FIG. 1A illustrates an input image in its preferred viewing orientation;

FIG. 1B illustrates an input image rotated 90°;

FIG. 1C illustrates an input image rotated 180°;

FIG. 1D illustrates an input image rotated 270°;

FIG. 2 illustrates a computer system which implements an embodiment of the invention;

FIG. 3 illustrates the components of an image orientation module used to implement an embodiment of the invention;

FIG. 4 is a flowchart illustrating the steps of a orientation detection method;

FIG. 5A illustrates an input image;

FIG. 5B illustrates the input image of FIG. 5A that has been resized;

FIG. 6 is a flowchart illustrating the steps of a sky detection method;

FIG. 7 illustrates an input image at a 90° rotation that is input to the sky detection method;

FIG. 8 illustrates the results of the sky detection method segmenting the input image of FIG. 7;

FIG. 9 illustrates a sky mask that is created by the sky detection method;

FIG. 10 is a flowchart illustrating the steps of a foliage detection method;

FIG. 11 illustrates an input image at its preferred viewing orientation that is input to the foliage detection method;

FIG. 12 illustrates a foliage mask that is created by the foliage detection method;

FIG. 13 is a flowchart illustrating the steps of a wall detection method;

FIG. 14 is an input image that is provided to the wall detection method;

FIG. 15 is an illustration of an image that has its low variance (smooth) regions highlighted by the wall detection method;

FIG. 16 is an illustration of the image of FIG. 15 that has its three largest low variance regions retained;

FIG. 17 is an illustration of an image segmented by the wall detection method;

FIG. 18 is an illustration of an image that has had a high threshold factor applied to it by the wall detection method;

FIG. 19 is an illustration of the final wall mask produced by the wall detection method;

FIG. 20 is an illustration of a central quadrant mask;

FIG. 21 is an illustration of a border mask;

FIG. 22 is a flowchart of the steps of a flesh detection method;

FIG. 23 is a flowchart of the steps of an eye detection method;

FIG. 24 is an illustration of an input image that is input to the eye detection method;

FIG. 25 is an illustration of the input image of FIG. 22 that has segmented objects identified;

FIG. 26 is an illustration of an abstracted pixilation pattern which represents the presence of eyes in an image;

FIG. 27 is an image illustrating the triangle regions found on the upper face of humans;

FIG. 28 is a flowchart illustrating the steps of an upper face detection method;

FIG. 29 is a flowchart of the steps of a straight line detection method;

FIG. 30 is a flowchart of the steps of a final classifier method;

FIG. 31 is a flowchart of a film roll orientation method.

FIG. 32 is a flowchart of a method of identifying an orientation of an image;

FIG. 33 is a flowchart of a method of implementing a step of the method of FIG. 32;

FIG. 34 is another flowchart of a method of implementing a step of method of FIG. 32; and

FIG. 35 is a flowchart of a method of implementing a step of FIG. 32.

### DETAILED DESCRIPTION OF THE INVENTION

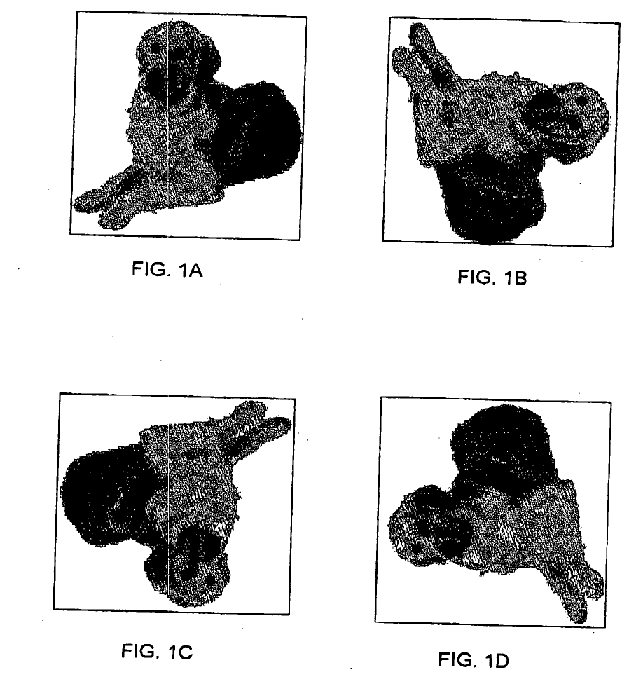

Images stored upon storage mediums or used in software applications may be oriented in orientations other than their preferred viewing orientations. For example, an image that is captured by a film-based camera may be developed, and then scanned, and depending on the manner in which the image was placed on the scanner, the image may be captured such that it is not in its preferred viewing orientation. When a picture (image) is scanned upon a scanner, it is likely that it is scanned in one of four orientations, as one edge of the picture is likely aligned with the edge of the scanner. Therefore, images are likely to have one of four orientations when stored upon a storage medium or when used by a software application. Reference is now made to FIGS. 1A to 1D, where these four orientations are illustrated FIG. 1A illustrates an image that is in its preferred viewing orientation, and has thus been rotated 0° from its correct orientation. FIG. 1B illustrates the image that has been rotated 90° from its preferred viewing orientation. FIG. 1C illustrates the image of FIG. 1A that has been rotated 180° from its preferred viewing orientation. FIG. 1D illustrates the image of FIG. 1A that has been rotated 270° (−90°) from its preferred viewing orientation. Although an image will generally be classified as being in one of four orientations as illustrated with reference to FIGS. 1A to 1D, images may be oriented and accordingly classified such that they are in various orientations (any degree between 0° and 360°)

The invention relates to a system and method by which the orientation of an image relative to its preferred viewing orientation is determined. The invention makes use of a plurality of algorithms which are used to make a determination as to whether certain features are present in an image (features such as sky, foliage and human eyes), and then to use the presence of those features to determine which classification algorithm from a number of classification algorithms to use and to use that classifier to determine the orientation of the image.

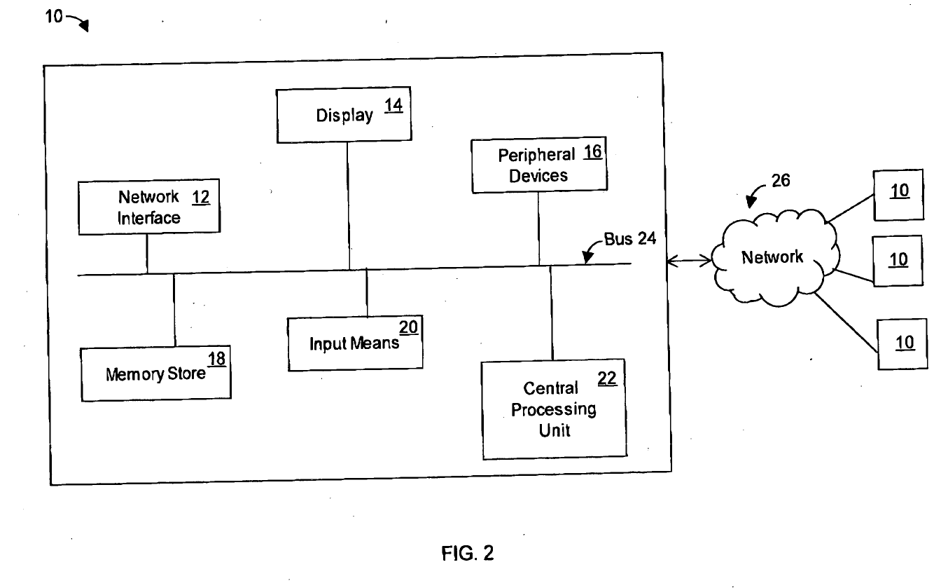

Reference is now made to FIG. 2, where the components of a computing system 10 which may be used to implement the system and method of the invention are shown. The computing system 10 may be any general purpose computing device, such as a desktop computer, slim line computer, laptop computer, work station computer, personal hand held computer, or any other such computing device. The computing system in one embodiment may include the following components: a network interface 12, a display 14, peripheral devices 16, a memory store 18, input means 20, a central processing unit (CPU) 22, and a bus 24. The computing system 10 may communicate with a network 26, which may be connected to other computing systems 10.

The network interface 12 can enable the computing system 10 to communicate with a network 26 and other computing systems 10. The network interface 12 may be a modem, Ethernet connection, cable connection or any other similar means which allows for connectivity to a network 26. The display 14 may be a monitor, television, projector or any other output means which provides display functionality.

The peripheral devices 16, may be any type of peripheral input or peripheral output devices. Examples of such peripheral devices include printers, scanners, speakers, CD ROMs, DVDs. The memory store 18 is a non-volatile memory storage means that is part of the computer system 10. Examples of such memory stores may include conventional hard drives which are used to store computer readable instructions, the operating system, data, data structures, and software applications. The memory store may also include in addition non volatile memory storage means, such as RAM, SRAM, and DRAM.

The input means 20 are the means used to enter commands and input into the computer system 10. Examples of such input means include, but are not limited to, keyboards, pointing devices such as a mouse, microphones, and other such suitable devices by which commands may be input to the computer system 10.

The central processing unit (CPU) 22 is used to execute program instructions which control the operation of the computing system 10. The components as described herein with respect to the computing system 10, may be in communication with one another by means of a bus connection 24. The bus connection 24 refers to one or more bus connections which connect components or devices to the computing system 10. The computing system 10 may communicate via the network interface 12 with a network 26. The network 26 may be any type of network which allows for the transmittal and receipt of data, examples of which include the Internet, the Intranet, and other networks capable of data transmission.

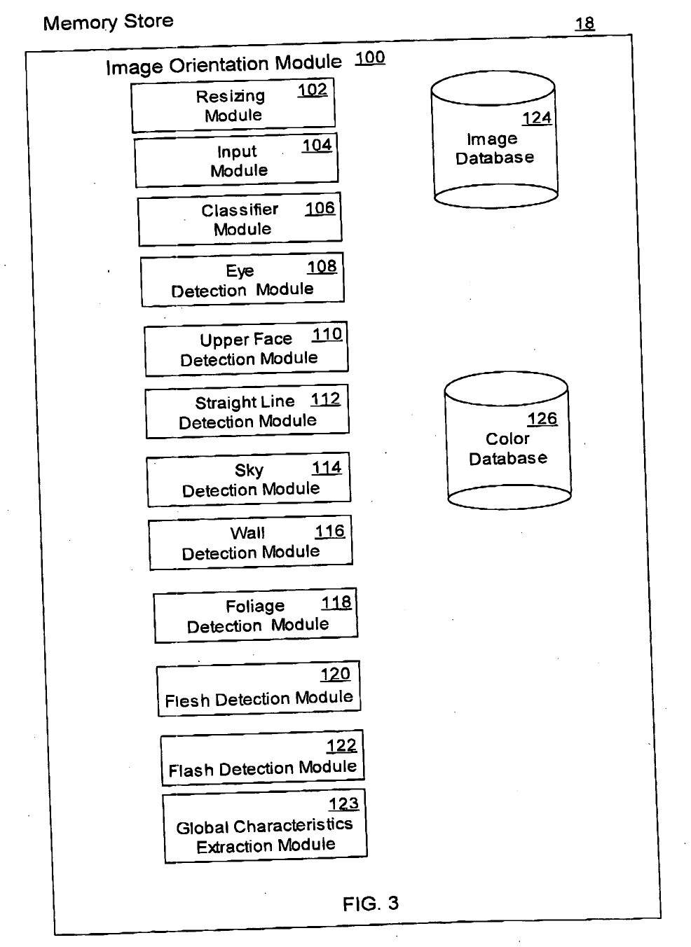

Reference is now made to FIG. 3, where the contents of the memory store 18 are illustrated in further detail. In order to implement the orientation classification method as is described in further detail below, the computer system 10 can access an image orientation module 100. The image orientation module 100 in one embodiment is stored upon the storage means 18 associated with the computing system 10. The orientation module 100 is a software application which contains program code and data that is used in the orientation classification method as is described in detail below.

The orientation module 100 comprises one or more sub modules. The sub modules contain program code and perform specific algorithms. In one embodiment of the invention, the image orientation module 100 includes a resizing module 102, an input module 104, a classifier module 106, an eye detection module 108, an upper face detection module 110, a straight line detection module 112, a sky detection module 114, a wall detection module 116, a foliage detection module 118, a flesh detection module 120, a flash detection module 122 and a global characteristics extraction module 123.

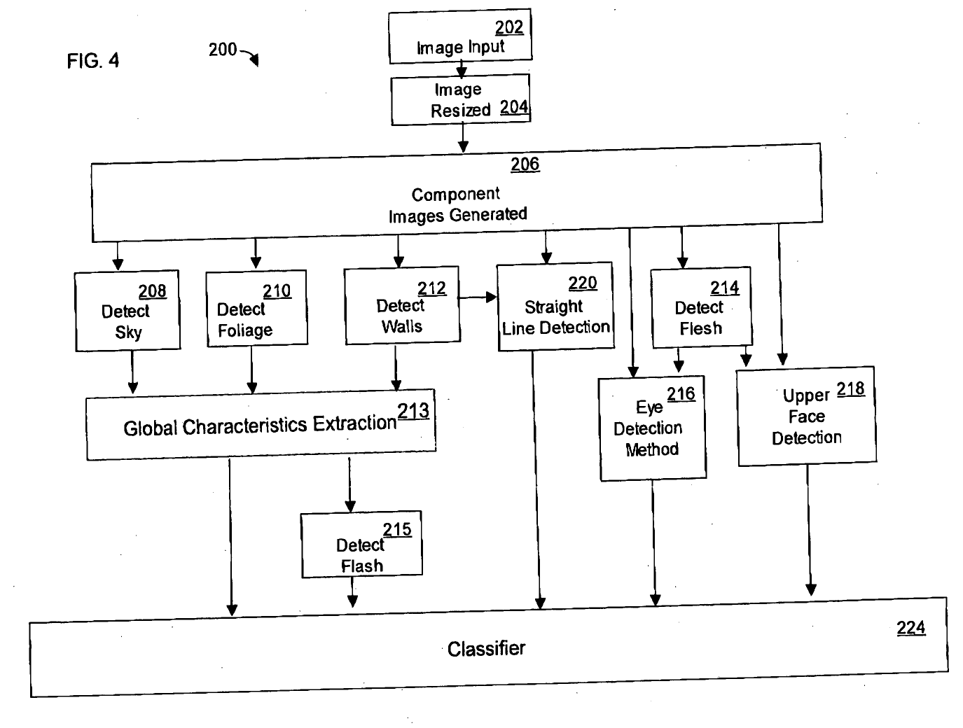

The resizing module 102 is used to resize images so that the orientation classification method may attempt to determine the orientation of an image in a computationally efficient manner. The input module 104 handles requests for an image orientation to be determined, and provides to the user the appropriate interface for the user to interact with the image orientation module 100. The classifier module 106 receives input (information concerning features found in the image and characteristics of the image) from the other modules which have executed algorithms, and determines a final image orientation. The eye detection module 108 is used to detect eyes and to determine the orientation of the eyes in the image of interest and to provide information about these eyes to the classifier module. The upper face detection module 110 is used to detect the upper face regions of human faces and to determine the orientation of the upper faces in the image of interest and to provide information about these upper faces to the classifier module 106. The wall detection module 116 is used to detect the presence of walls in an input image, and this information is then used by the straight line detection algorithm and is also provided to global image characteristic extracting module. The straight line detection module 112 is used to detect any lines in an image which may be primarily vertical or horizontal, as these lines may serve as indication of perspective. Information from the straight line detection module is provided to the classification module 106. The sky detection module 114 is used to detect whether elements of the sky may be found in an input image, and this information is then provided to the global image characteristic extracting module and provided to the classifier module 106. The foliage detection module 118 detects the presence of foliage (i.e. grass, trees, leaves) that may be present within an input image and this information is then provided to the global image characteristic extracting module and provided to the classifier module 106. The flesh detection module 120 is used to detect instances or human flesh which may be found in an input image, and this information is then used by the eye detection module, the upper face detection module, and the global image characteristic extracting module. The flash detection module 122 is used to detect occurrences of a camera flash which may have been used when the image was captured and this information is then provided to the classifier module. The global characteristics extraction module 123 is used to extract characteristics from images which are used to determine the orientation of the image. The term features is used to refer to objects or occurrences which the detection algorithms search for, and includes but is not limited to instances of sky, eyes, upper faces, flesh, straight lines, walls, foliage, flesh and flashes. The image database 124 is a database that stores real world random images. The image database 124 may include images such as scenery, children, events, parties, etc. The images stored in the image database contains images that are stored at one of four orientations with respect to their natural orientation (0°, 90°, 180°, or 270°(−90°)). For each feature the database contains images of features taken from other images at the four different orientations, and each image of a feature at a different orientation as stored in the database is referred to as a feature template. The color database 126 is used to store color data (i.e. red, green and blue intensity) from elements that have been taken from other images, as well as data pertaining to the relationships that may exist between the color components (i.e the relationship between the red and green components for sky images). The color data and associated relationships that exist for images that relate to a feature are referred to as feature records. Both feature records and feature templates which are used for a specific feature may contain information and data that relates to the inclusion of other features within the images from which they were derived. Reference is now made to FIG. 4, where the steps of an image orientation detection method 200 are shown. Orientation detection method 200 encompasses the running of one or more processes which provide input to a classification method, which takes the input and attempts to determine the final classification as to the orientation of the image. Method 200 begins at step 202 where the image to be classified is input.

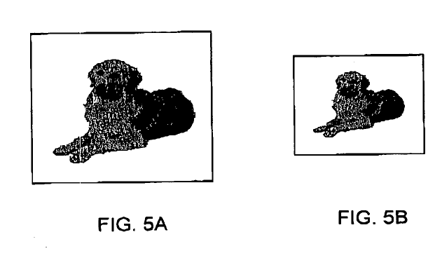

Method 200, upon the image being input, proceeds to step 204, where the image may be resized. Resizing an image, often into a smaller size (i.e. a decrease in image resolution) will result in less computation time being required to process the image, and will have little effect on the outcome of the image orientation detection method 200. Reference is made to FIGS. 5A and 5B where an example of an input image (5A) that is being resized (5B) is shown. In one embodiment, if the input image is greater than 500 pixels in width, it is resized to 500 pixels in width, and is done so such that its image aspect ratio is maintained (i.e. the height is resized by the same factor as the width). If the input image is less than 500 pixels in width, the image is not resized. Other threshold widths may also be used when resizing the image, as 500 pixels in width has been provided for purposes of example only.

Method 200 then proceeds to step 206, where component images from the image are extracted. As a digital image is made up of rows and columns of “pixels”, the color of each pixel in a color image can be described by a combination of three primary colors; red, green and blue. The color depth for each pixel specifies the number of different color levels that any pixel in the image can have. Typically color depth is expressed in terms of the number of bits of resolution used to encode color information A common color resolution is 24 bits. At this resolution 8 bits are used to encode red intensity, 8 bits for green intensity, and 8 bits for blue intensity. Therefore, for each color component there are 28 or 256 different intensities ranging from 0 to 255. An intensity of 0 indicates an absence of a particular color and 255 indicates that the particular color has a maximum intensity at that particular pixel. The red, blue, and green component images are extracted from the input image at step 206. The respective color component images indicate the color level intensity at each pixel (i.e. the red value for each component) throughout the image. At step 206 along with the red, green, and blue component extraction processes, an intensity component for the image is extracted. An intensity level for each pixel may be determined by a variety of equations. One such equation is:
Intensity=(red_{—}intensity*38+green_{—}intensity*75+blue_{—}intensity*15)/128.
Another equation which may be used is based on determining the intensity of each color component. The equation is as follows:
Intensity=(red_{—}intensity+green_{—}intensity+blue_{—}intensity)/(255*3).

Also at step 206, an intensity edge is calculated for the image. An intensity edge allows for discontinuities in an image to be identified. A convolution function is used to determine the intensity edge for the image. A convolution function takes two functions (f and g for example) and produces a third function that represents the overlap between f and a reversed and translated version of g. Therefore, to determine the intensity edge image, the intensity image is convolved with the following matrix (which may also be referred to as a kernel):

$$\begin{matrix}- 1 & - 1 & - 1 \\ - 1 & 8 & - 1 \\ - 1 & - 1 & - 1\end{matrix}$$

This kernel (matrix) is one example of an edge detection kernel that may be used, as there are other edge detection kernels that may be used.

At the conclusion of step 206, the red, blue and green component images will have been determined, along with the intensity and intensity edge images for the image that was input at step 202. Method 200 may then proceed to a variety of steps which may be run in parallel, or in sequence. The order in which the steps after step 206 are run will be determined by the classifier as implemented by the classification method as shown at step 224, and is described in detail below. Specifically, method 200 upon the extraction of the component images may proceed to various steps. Some methods are required to be performed before other methods and their respective algorithms may be carried out. For example, step 212, which is used to detect the presence of walls in an image is run before the step 220 which is used to detect straight lines in an image. Also, step 214 which is used to detect instances of flesh found in an image is run before steps 216 and 218, as flesh regions are used to located eyes and instances of the upper face in humans.

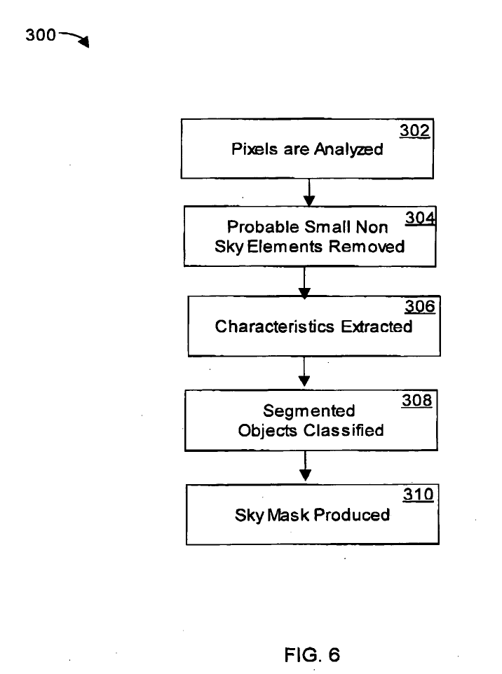

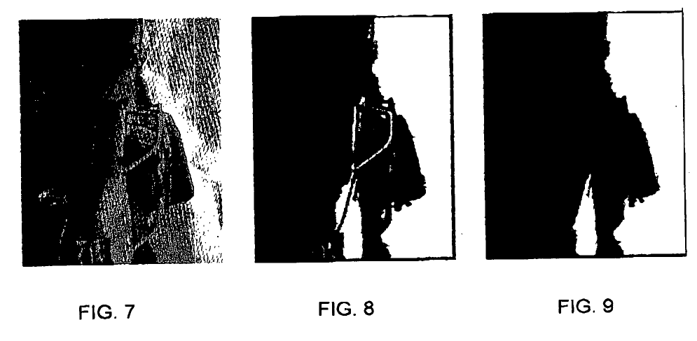

Method 200 at step 208 employs a sky detection algorithm. In images that are captured outdoors, the sky is one of the most frequently found features in images. Therefore, knowledge of the location of the sky in an image, aids in determining the orientation of the image, as the sky is generally found towards the top of the image. The sky detection method is further described with reference to FIG. 6. Reference is now made to FIG. 6 where the steps of a sky detection method 300 are shown. The sky detection method 300 is described with reference to FIGS. 7-9 which illustrate the steps that are performed in the method. The sky detection method 300 receives an input image, an example of which is shown in FIG. 7 which may contain images associated with the sky and creates an image so that regions which represent the sky have been segmented. The sky detection method 300 begins at step 302, where all the pixels in the image are analyzed to determine whether they meet specific color criteria as contained in the feature record for this particular feature (sky). The criteria are based on absolute intensity ranges for red, green, and blue values and the relationships between the red, green, and blue intensity values. These criteria have been defined by analysis of the relationship between pixels which represent the sky in other images. The color database 126 stores in the respective feature record sky color data which is used when performing step 302. The respective feature record specifically includes the red, green, and blue image plane values that are associated with the appearance of the sky in other images. A graph of the relationship between the green and blue pixel values taken from the sky part of other images will generally show that the relationship is linear. As a result of each pixel being analyzed at step 302, brighter regions may be found on an image, which correspond to regions with colors similar to the colors in the sky examples, and the image will have been segmented. The brighter regions, which are referred to as segmented objects are represented by white pixels, whereas the other pixel will be black. Each segmented object is defined as a collection of white pixels which are adjacent to other white pixels (vertically, horizontally or diagonally). Reference is made to FIG. 8, where an image showing segmented objects (in white) is shown, which results from the execution of step 302.

Method 300 then proceeds to step 304, where probable non sky elements are removed from the segmented objects which have been identified in step 302. These segmented objects (usually very small areas on the image) are removed through use of binary erosion and dilation operations.

A binary erosion replaces each pixel intensity with the minimum intensity of the pixel and its surrounding pixels in the original image. For example:

$$\text{the original image:}$$

$$\begin{matrix}0 & 0 & 0 & 0 & 0 & 0 & 0 & 0 \\ 0 & 0 & 1 & 1 & 1 & 1 & 1 & 0 \\ 0 & 0 & 1 & 1 & 1 & 1 & 1 & 0 \\ 0 & 0 & 1 & 1 & 1 & 1 & 1 & 0 \\ 0 & 0 & 0 & 0 & 0 & 0 & 0 & 0\end{matrix}$$

$$\text{becomes:}$$

$$\begin{matrix}0 & 0 & 0 & 0 & 0 & 0 & 0 & 0 \\ 0 & 0 & 0 & 0 & 0 & 0 & 0 & 0 \\ 0 & 0 & 0 & 1 & 1 & 1 & 0 & 0 \\ 0 & 0 & 0 & 0 & 0 & 0 & 0 & 0 \\ 0 & 0 & 0 & 0 & 0 & 0 & 0 & 0\end{matrix}$$

For a binary image, each of the numbers in this image can only be 0 or 1.

A binary dilation replaces each pixel intensity with the maximum intensity of the pixel and its surrounding pixels in the original image. For example,

$$\text{the original image:}$$

$$\begin{matrix}0 & 0 & 0 & 0 & 0 & 0 & 0 & 0 \\ 0 & 0 & 1 & 1 & 1 & 1 & 1 & 0 \\ 0 & 0 & 1 & 1 & 1 & 1 & 1 & 0 \\ 0 & 0 & 1 & 1 & 1 & 1 & 1 & 0 \\ 0 & 0 & 0 & 0 & 0 & 0 & 0 & 0\end{matrix}$$

$$\text{becomes:}$$

$$\begin{matrix}0 & 1 & 1 & 1 & 1 & 1 & 1 & 1 \\ 0 & 1 & 1 & 1 & 1 & 1 & 1 & 1 \\ 0 & 1 & 1 & 1 & 1 & 1 & 1 & 1 \\ 0 & 1 & 1 & 1 & 1 & 1 & 1 & 1 \\ 0 & 1 & 1 & 1 & 1 & 1 & 1 & 1\end{matrix}$$

As a result of the binary erosion and dilation operations small segmented objects which had been segmented as possibly being representative of the sky are removed from the image. Reference is made to FIG. 9, where the segmented sky mask that is the result of step 304 is shown.

Method 300 then proceeds to step 306, where characteristics of each object in the segmented sky mask are extracted. The characteristics that are extracted may include the original color of each segmented object, and its original color texture as well as the original color and texture surrounding the object. As an example, the color characteristics that are abstracted may include the mean red intensity of the object, the maximum red intensity within the object, and the mean green intensity of the object. Texture characteristics may be calculated by measuring the pixel intensities in the object after an edge filter has been used on the image.

Method 300 then proceeds to step 308, where each segmented object is classified on the likelihood that the object is either sky or not sky. The likelihood that an object that has been segmented represents the sky can be determined by calculating the degree of similarity between a segmented object and a sky paradigm cluster. The likelihood may be determined by calculating the object's feature space quadratic distance to a training sky feature cluster

The equation for the quadratic classifier distance (Q) when the object that is being determined is the sky is:
Q=Features*A*Features′+b*Features+c
where:

Features=the feature vector describing the object to be classified
A=inv(K_non_object_of interest)−inv(K_object_of_interest)
K_non_object_of_interest=covariance matrix of the non object of interest training class
K_object_of_interest=covariance matrix of the object of interest training class
b=2*inv(K_object_of_interest)*m_object_of_interest−inv(K_non object_of interest)
m_non_object_of_interest
m_non_object_of_interest=mean of the non object of interest class
m_object_of_interest=mean of the object of interest class
c=m_non_object_of_interest*inv(K_non_object_of_interest)*m_non_object_of_interest′−m_object_of_interest*inv(K_object_of_interest)*m_object_of_interest′

The likelihood that an object is a sky element is proportional to the feature space quadratic distance calculated using the above function. If Q is higher than or equal to a selected threshold, then the object is classified as being part of the sky, while if Q is lower than the given threshold, the object is classified as not sky. The threshold is set at a level that produces an acceptable compromise between false positives and false negatives. That is, the threshold is set at a level that enables an acceptably high proportion of sky to be detected, while minimizing the number of objects that are erroneously identified as sky. This classification process produces the sky mask at step 310. The sky mask that is produced at this step is what is analyzed further to attempt to determine the orientation of the input image.

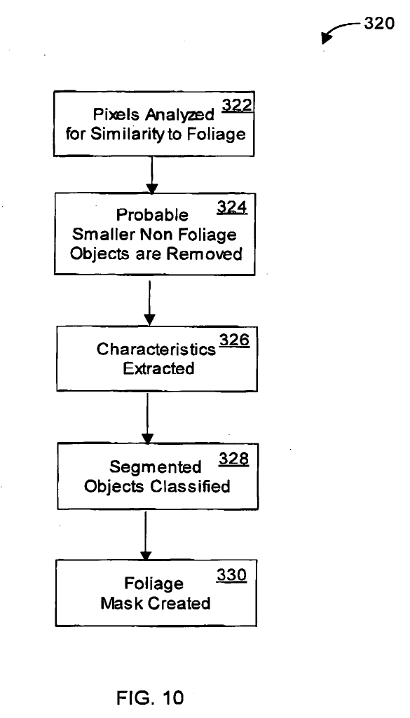

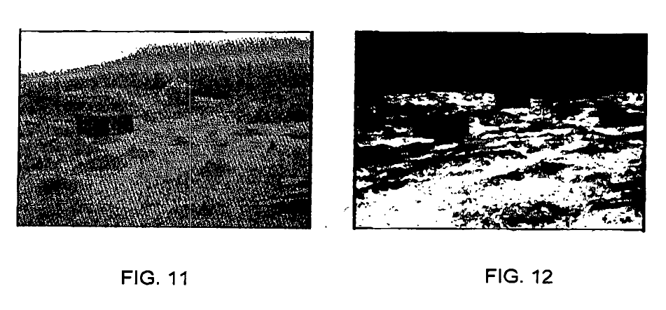

At step 210 a foliage detection algorithm is employed. The foliage detection algorithm attempts to segment an input image such that the areas in the input image which contain foliage are identified. The term foliage is used herein to refer generally to leaves, grass, trees, plants and other forms of vegetation which may be captured in an image, and as such foliage which may be of varied colours, including green, yellow, brown or other colours will attempt to be located in the input image. The determination of the location of the foliage in an image will aid in determining the orientation of the image, as for example, if foliage is found closer to one border of the image, and little or no foliage is found at the parallel border, the indication will be that the border with the foliage is likely the bottom of the image. Reference is made to FIG. 10, where the steps of the foliage detection method 320 are shown. Method 320 is described with reference to FIG. 11 and FIG. 12. FIG. 11 is representative of an image upon which the foliage detection method 320 operates, and FIG. 12 represents the foliage mask that is produced upon the conclusion of the foliage detection method 320. Method 320 begins at step 322 where foliage detection is performed by analyzing the pixels in the input image to determine whether they meet certain color criteria as specified in the feature record associated with foliage. The color criteria are based on foliage color data information contained in the feature record which is determined by the analysis of foliage in other images. The criteria may be based on the absolute intensity ranges for the red, green, and blue components, and any relationships that exist between the red, green, and blue intensities. The foliage feature record includes information pertaining to the color criteria and relationships that exist between the color components for foliage as stored in the color database 126. The foliage feature record similar to the sky feature record, started with the collection of color data from other images indicating the blue, green, and red pixel levels that are associated with foliage instances. Analysis of the foliage color data taken from a variety of images will reveal the following general trends; that there exists a linear relationship between the green and blue image planes, a linear relationship between the green and red image planes and a linear relationship between the blue and red image planes. The analysis of all the pixels undertaken at step 322 with respect to the feature record associated with foliage, results in bright regions being highlighted in the image. The bright regions are represented by white pixels and the other pixels will be black, and the bright regions will represent segmented objects. A single segmented object is defined as a collection of white pixels that are adjacent (either horizontally, vertically, or diagonally) attached to one another.

Method 320 then proceeds to step 324 where small probable non foliage objects are removed from the segmented objects. These objects are removed by means of binary erosion and dilation operations as described above.

The conclusion of step 324 results in the creation of a segmented foliage mask. Method 300 then proceeds to step 326, where the characteristics of the segmented objects in the segmented foliage mask are extracted. Various characteristics of the segmented objects may be extracted, including without limitation the original color of each segmented object, the original color texture as well as the original color and texture of the region surrounding the object. Specifically, color characteristics may include the maximum red intensity within the object, and the mean green intensity of the object. Texture characteristics may be calculated by measuring the pixel intensities in the object after an edge filter has been applied on the image.

Method 320 then proceeds to step 328, where each segmented object is classified as either being representative of foliage or not, based on the characteristic data that was extracted at step 326. The likelihood that a segmented object is foliage is determined by calculating the degree of similarity between the segmented object and foliage paradigm cluster. This likelihood may be determined by calculating the object's feature space quadratic distance to a training foliage feature classifier. The equation for the quadratic classifier distance (Q) is the same as was shown above. Method 320 at the conclusion of the classification process for each segmented object results in the creation of a foliage mask at step 330.

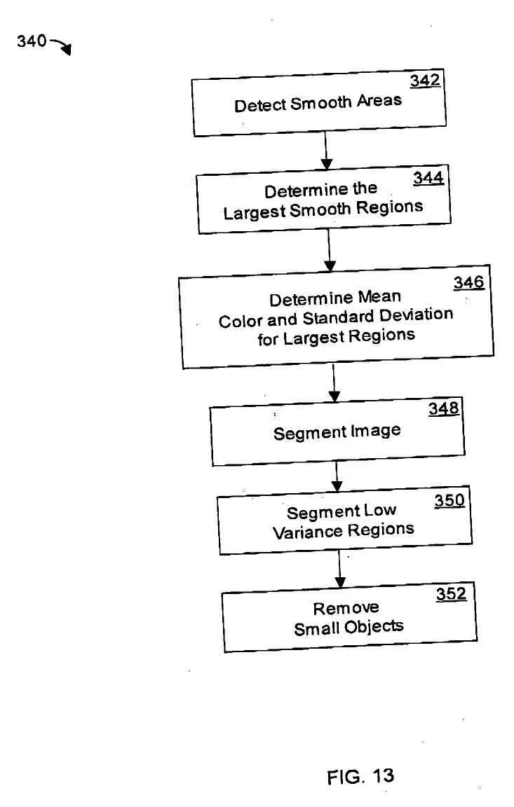

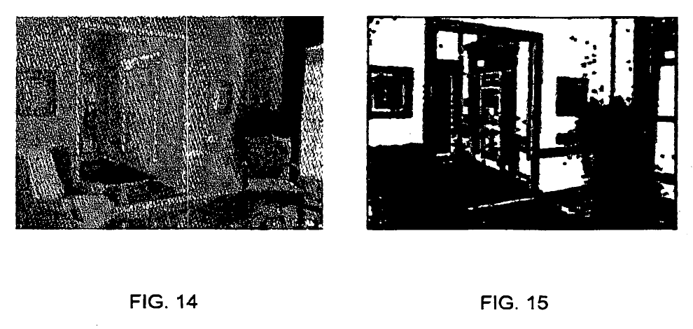

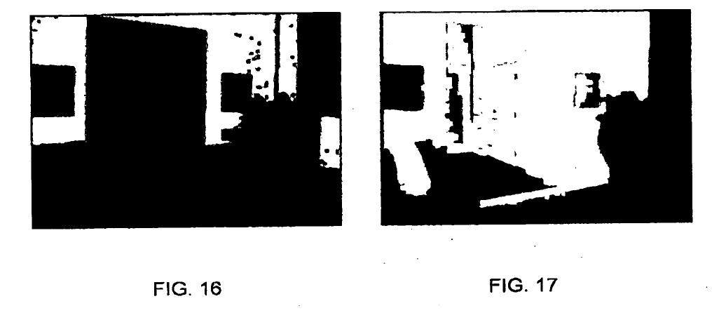

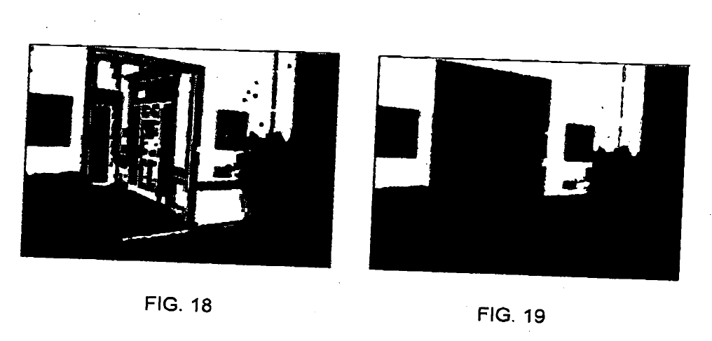

At step 212, the input image is analyzed in an attempt to determine the presence of any walls in the image. Step 212 is carried out by a wall detection algorithm as implemented in wall detection method 340. The presence of walls in an image provide information as to the orientation of the image, as walls are more likely to be found in an image either at the top or sides of an image. The wall boundaries are also used in the line detection module. The wall detection method 340 will produce a segmented image which will attempt to segment the walls found in an input image, and as such this information can then be used to help to determine the orientation of the image. Reference is made to FIG. 13, where the steps of the wall detection method 340 are shown. The wall detection method 340 is illustrated by reference to FIGS. 14-19. Wall detection method 340 begins at step 342. At step 342, the low variance regions of image are detected. The low variance regions of the image generally relate to areas which in the image are smooth, which will generally be representative of wall regions. Step 320 is carried out by thresholding the edge intensity image which was determined at step 206 to finding regions of interest with low intensity. These low intensity regions in the edge image represent regions of low variance or smooth regions in the original intensity image, as illustrated in FIG. 15. Method 340 then proceeds to step 344, where the largest smooth regions (low variance regions) are identified. The largest smooth regions are identified by performing a pixel analysis to determine the area that is taken up by each of a set of common pixels that make up the low variance regions as shown in FIG. 15. In one embodiment of the method, at step 344 the three largest low variance or smooth regions are used for further processing. Reference is made to FIG. 16 where the three largest low variance regions are highlighted. Method 340 then proceeds to step 346 where for each of these regions, the mean color intensity and standard deviation are determined. Method 340 then proceeds to step 348 where the original image is segmented such that pixels with colors similar to the mean colors extracted (colors of interest) in step 346 are now pixels of interest. Reference is made to FIG. 17 which displays the outcome of the segmentation process undertaken at step 348. Method 340 then proceeds to step 350. At step 350 the low variance regions of the image like those that have been determined at step 342 are segmented. At step 350 however, a higher threshold factor is used to increase the number of regions that are retained as low variance regions as is illustrated in FIG. 18. These low variance regions and the pixels extracted in step 346 are logically AND'ed to produce an image with regions segmented that are of the colors of interest and that are smooth in texture. Method 340 then proceeds to step 352, where small objects within the low variance segments are removed from the segmentation that is being performed, as is shown in FIG. 19. FIG. 19 represents the final wall segmentation image which is produced as a result of the wall detection method 340, and is referred to as a wall mask.

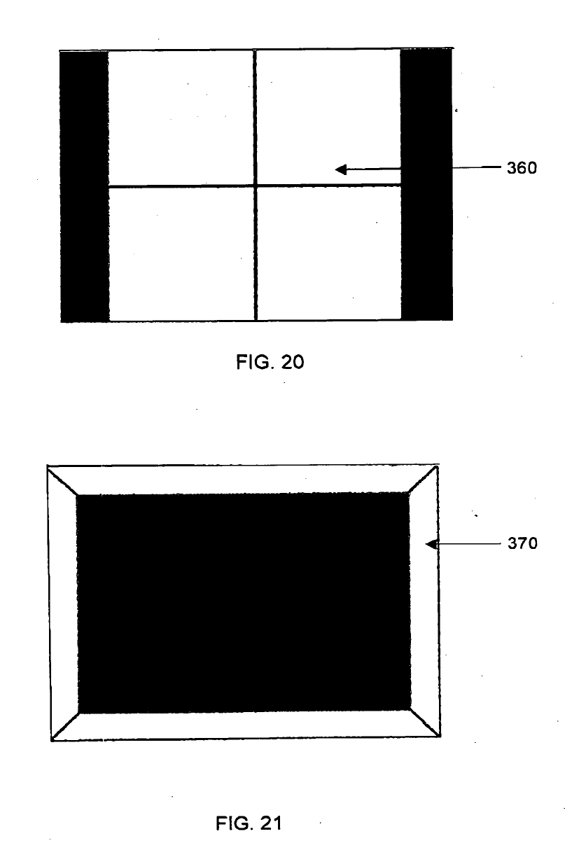

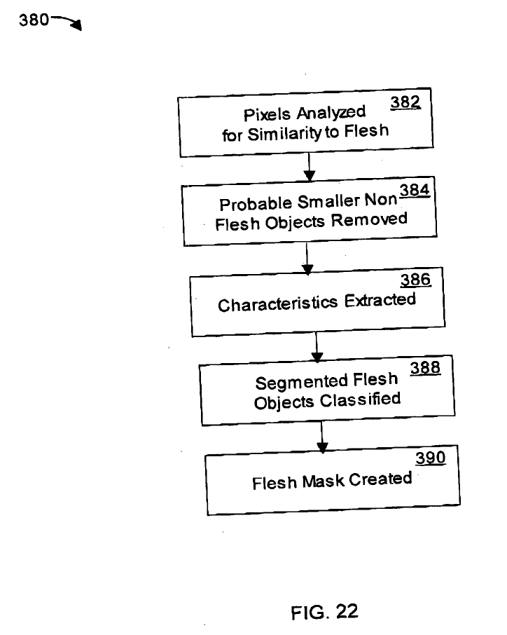

At step 213 a global characteristics extraction method is performed. The global characteristics extraction method extracts image characteristics from the component images, the intensity image, the edge intensity image, the sky mask, the wall mask, the foliage mask and the flesh mask. The global characteristics extraction method operates on the component images and the various masks that have been created by the respective detection methods. The characteristics extraction method analyzes both the center and border regions of the respective masks. Reference is made to FIG. 20 where a central quadrant mask 360 is shown. The central quadrant mask 360 as shown in FIG. 20 is divided into four equal size quadrants, however the central quadrant mask may be divided into many quadrants and may use shapes other than rectangular shapes. Reference is also made to FIG. 21 where a border mask 370 is shown.

The global characteristics extraction method is now explained in further detail with respect to the operation of the central quadrant mask 360 and its operation on the specific masks and component images. As is shown in FIG. 4, the characteristics extraction method receives input from the component images, the intensity image, the edge intensity image and the specific masks that have been created by the detection methods. The location of the features within the mask as well as with color and intensity characteristics within the quadrant masks are then used by the classifier 224 to make a decision as to image orientation. For the specific masks the central quadrant mask is used to determine the location of features found in the non border regions of the image. The border mask 370 as shown in FIG. 21 is used to determine whether features (taken from the respective masks) that have been created are found in the border regions. For the component, intensity and edge intensity images the central quadrant mask is used to determine the average pixel intensities, the standard deviation of pixel intensities and the centre of gravity for the pixel intensities within each central quadrant mask region of the image. As an example, the following values may be generated by the global characteristics extraction method: average blue intensity within the top right quadrant=201, average blue intensity within the top left quadrant=180, average blue intensity within the bottom right quadrant=60, average blue intensity within the bottom left quadrant=45. This information will be used by the classifier 224 to make a final determination as to image orientation.

As an example of the operation of the characteristics extraction method, and its operation with a central quadrant mask will be described with respect to a sky mask. The sky detection method provides to the characteristics extraction method the sky mask that was created. The central quadrant mask is then used to analyze the sky mask according to where sky has been located in the image. As an example, an analysis of sky masks may reveal that the percentage of the area within each quadrant mask that is sky (for example: percentage of the top right quadrant that is sky=95%, percentage of the top left quadrant that is sky=80%, percentage of the bottom right quadrant that is sky=6%, percentage of the bottom left quadrant that is sky=10%) is information that will be used by the classifier 224 to make a final determination as to image orientation

At step 214 a flesh detection algorithm is performed. The detection of human flesh within an image will aid in determining the orientation of an image, as humans will generally be located centrally in the image, as well as possibly being located at the upper or lower portions of the images. Reference is made to FIG. 22 where the steps of a flesh detection method 380 are shown. The flesh detection method 380 will attempt to segment an input image so that human flesh which may be of various colours, including, but not limited to various shades of beige, pink, yellow, or brown.

Method 380 begins at step 382 where the appearance of human flesh is attempted to be determined by analyzing the pixels in the input image to determine whether they meet certain color criteria as contained within the flesh feature record. The feature record contains data that is based on flesh color data information which is determined by the analysis of human flesh that has been taken from other images. The criteria are similar to the criteria used in the sky and foliage detection methods, which may be based on the absolute intensity ranges for the red, green, and blue components, and any relationships that exist between the red, green, and blue intensities. The flesh feature record includes information pertaining to the color criteria and relationships that exist between the color components stored in the color database 126. The flesh feature record, similar to the sky feature record, and foliage feature record is based on the collection of color data from other images indicating the blue, green, red pixel levels that are associated with flesh instances which may be found in those other images. Analysis of the flesh color data taken from a variety of images will reveal that in flesh pixels the red values are greater than the green ones. The analysis of all the pixels undertaken at step 382 results in bright regions being highlighted in the image which correspond to regions with colors that are comparable to colors that are found in flesh. The bright regions are represented by white pixels and the other pixels will be black, as the bright regions represent segmented objects. A single segmented object is defined as a collection of white pixels that are adjacent (either horizontally, vertically, or diagonally) attached to one another.

Method 380 then proceeds to step 384 where small probable non flesh objects are removed from the segmented objects. These objects are removed by means of binary erosion and dilation operations as have been described above.

The completion of step 384 results in the creation of a segmented flesh mask. Method 380 then proceeds to step 386, where the characteristics of the segmented objects in the segmented flesh mask are extracted. Various characteristics of the segmented objects may be extracted, including without limitation the original color of each segmented object, the original color texture as well as the original color and texture of the region surrounding the object. Specifically, color characteristics may include the maximum red intensity within the object, and the mean green intensity of the object. Texture characteristics may be calculated by measuring the pixel intensities in the object after an edge filter has been applied on the image.

Method 380 then proceeds to step 388, where each segmented object is classified as either being representative of flesh or not, based on the characteristic data that was extracted at step 386. The likelihood that a segmented object is flesh is determined by calculating the degree of similarity between the segmented object and flesh paradigm cluster. This likelihood may be determined by calculating the object's feature space quadratic distance to a training flesh feature classifier. The equation for the quadratic classifier distance (Q) is the same as was shown above. Method 380 at the conclusion of the classification process for each segmented object results in the creation of a flesh mask.

At step 215, a flash detection method is performed on the input image. As images that that have been illuminated with the light from a flash, will generally have the subject (people or object of interest) in the image in the center and bottom, the detection of a flash in the image will aid in determining the orientation of the image. Flash images are detected using global image characteristics provided by the global characteristics extraction method. The image is classified as either being representative of a flash image or not, based on the characteristic data that was extracted at step 213. The likelihood that the image is a flash image is determined by calculating the degree of similarity between the image characteristics and a flash image paradigm cluster. This likelihood may be determined by calculating the image's feature space quadratic distance to a training flash image feature classifier. The equation for the quadratic classifier distance (Q) is the same as was shown above. At the conclusion of step 215, it can be determined as to whether image was taken using a flash or not.

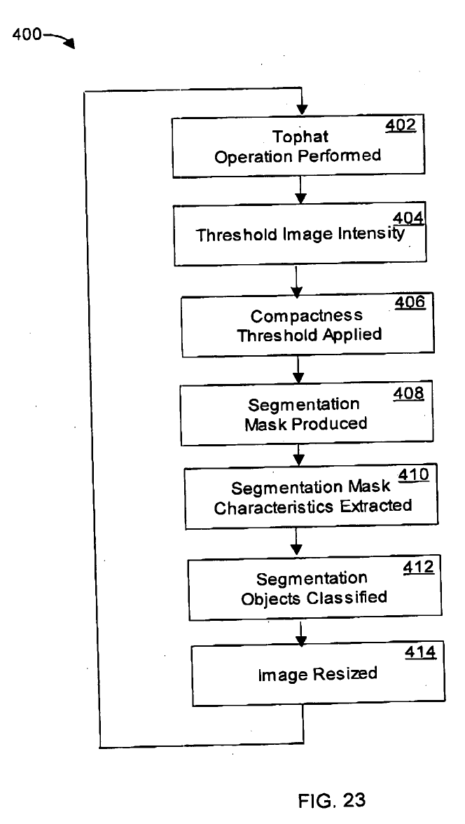

At step 216, an eye detection method is performed. Reference is made to FIG. 23 where the steps of an eye detection method 400 are shown. The eye detection method 400: receives an input image, along with input from the flesh detection method and attempts to determine whether any human or animal eyes are found in the image.

Method 400 begins at step 402 where at least one dark tophat operation is performed on the input image. A dark tophat operation (h) is defined as:
h=((fφb)Θb)−f

In the tophat operation (h), h is a 3×3 pixel square that is referred to as a structuring element, f is the input image, Θ indicates one or more grayscale image erosions, and φ indicates one or more grayscale image dilations.

As has been discussed above, a color image may be split into three greyscale images based on the red, green, or blue intensities of that image. A greyscale erosion is an operation performed on a greyscale image. In the eye detection method, this greyscale erosion is performed on the red intensity image which was generated at step 206. A greyscale erosion replaces each pixel intensity with the minimum intensity of the pixel and its surrounding (adjacent) pixels in the original image. As an example:

$$\text{the original image:}$$

$$\begin{matrix}5 & 4 & 3 & 5 & 5 & 2 & 1 & 6 \\ 3 & 6 & 5 & 9 & 8 & 7 & 7 & 2 \\ 3 & 4 & 1 & 4 & 9 & 9 & 8 & 9 \\ 9 & 9 & 8 & 8 & 7 & 2 & 3 & 5\end{matrix}$$

$$\text{becomes:}$$

$$\begin{matrix}3 & 3 & 3 & 3 & 2 & 1 & 1 & 1 \\ 3 & 1 & 1 & 1 & 2 & 1 & 1 & 1 \\ 3 & 1 & 1 & 1 & 2 & 2 & 2 & 2 \\ 3 & 1 & 1 & 1 & 2 & 2 & 2 & 3\end{matrix}$$

As made mention of above, each of the numbers that make up the image may vary between 0 and 255, and the numbers have been restricted to those between 1 and 9 to allow for ease of representation.

A greyscale dilation operation replaces each pixel intensity with the maximum intensity of the pixel and its surrounding pixels in the original image. As an example:

$$\text{the eroded image:}$$

$$\begin{matrix}3 & 3 & 3 & 3 & 2 & 1 & 1 & 1 \\ 3 & 1 & 1 & 1 & 2 & 1 & 1 & 1 \\ 3 & 1 & 1 & 1 & 2 & 2 & 2 & 2 \\ 3 & 1 & 1 & 1 & 2 & 2 & 2 & 3\end{matrix}$$

$$\text{becomes:}$$

$$\begin{matrix}3 & 3 & 3 & 3 & 3 & 2 & 1 & 1 \\ 3 & 3 & 3 & 3 & 3 & 2 & 2 & 2 \\ 3 & 3 & 1 & 2 & 2 & 2 & 3 & 3 \\ 3 & 3 & 1 & 2 & 2 & 2 & 3 & 3\end{matrix}$$

As a result of erosion and dilation operations, regions that have been identified as being brighter in the tophat image correspond to concentrations of dark pixels in the red component image. As mentioned above, the dark tophat operation involves first a dilation and then an erosion. In a dilation operation, the red color value for each pixel is changed to equal the maximum red color value in the 8 pixels surrounding that pixel. Therefore, as a result of each dilation operation, the borders that define a pixel cluster of dark intensity will move inwards. If the object that is the subject of the dark intensity pixels is sufficiently small or sufficient dilation operations are performed, then this region of dark intensity will be eliminated. Upon the completion of the dilation operation, an erosion operation is then performed, where an erosion operation is the reverse of the dilation operation that was performed. The erosion operation will result in replacing the red color value of a pixel with the maximum red color value for each of the eight pixels surrounding that pixel and that pixel itself. Therefore, if any of the original regions of dark redness to which the dilation operation were applied remain, then the erosion operation will result in the borders of this dark object expanding outwards. However, if the dark object had been completely eliminated by the dilation operation, then this erosion operation will not bring it back.

As shown in the above equation, after equal numbers of dilation and erosion operations have been applied to the red component image, the color values for the original red component image are subtracted from the corresponding eroded and dilated image, resulting in a tophat image in which bright regions correspond to concentrations of dark pixels in the red component image.

Method 400 then proceeds to step 404, where the tophat image which highlights the bright regions corresponding to dark pixels in the red component image is then intensity thresholded to further highlight brighter regions of interest. Upon highlighting regions of interest through intensity thresholding, method 400 then proceeds to step 406, where a compactness threshold is applied to the regions of interest to retain regions that may contain a human or animal eye. Compactness is defined by the following equation.
compactness=object perimeter/(4×π×object area)
where both the object perimeter and area are measured in pixels.

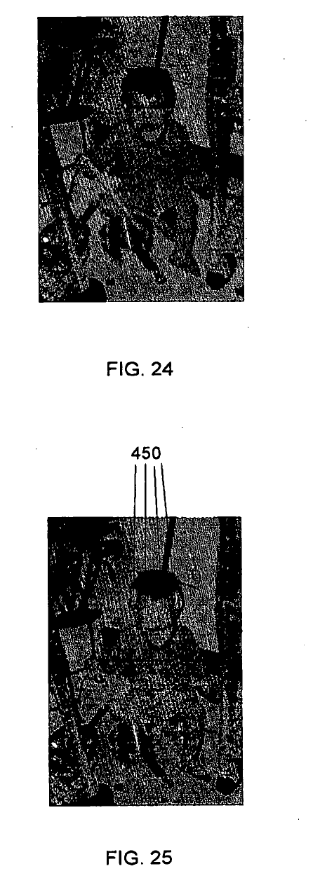

Method 400 then proceeds to step 408, where after the retention of objects within a compactness threshold as determined by the equation above, a segmentation mask of the image is produced. The retention of objects within a compactness threshold results in the removal of elongated dark patches which previously may have been highlighted, which are known to not represent either human or animal eyes. Reference is now made to FIGS. 24 and 25, where an input image is shown in FIG. 24, and a segmentation mask of the input image highlighting regions which may indicate the presence of eyes is shown in FIG. 25. FIG. 25 highlights a plurality of segmented objects 450. The segmented objects shown in FIG. 25 are represented by white pixels. As is seen in FIG. 25, at step 408, segmented objects 450 which are not representative of eyes are highlighted as well, and therefore further steps as described below are undertaken to determine which of those segmented objects represent human eyes. The mask generated from the flesh identification method is used at this point. Specifically, the flesh mask that has been created is dilated so that it is enlarged, and this is then combined (through use of a logical AND operation) with segmented dark regions that are identified through the eye detection method.

Method 400 then proceeds to step 410, where each segmented object 450 in the segmentation mask then has its characteristics extracted. Characteristics that are extracted may include the original color of each segmented object, the segmented shape, and the original color texture as well as the original color and texture of the region surrounding the object. As an example, the color characteristics which are extracted may include the mean red intensity of the object, the maximum red intensity within the object and the mean green intensity of the object. The shape features that are extracted may include perimeter and compactness information. The texture features may be derived by calculating the pixel intensities after an edge filter has been used on the image.

Method 400 then proceeds to step 412, where each segmented object 450 is then classified based on the likelihood that the object is either a human eye at 0°, a human eye at 90°, a human eye at 180°, or a human eye at 270% (−90°), or not a human eye. In one embodiment of the present invention, the likelihood that an object is an eye at X degrees (where X in this embodiment can be one of the four orientations for an image) may be determined by calculating the degree of similarity to an eye at X degrees paradigm cluster. This likelihood may be determined by calculating the object's feature space quadratic distance to a training eye at X degrees feature cluster.

The equation for the quadratic classifier distance as described above (Q) is used.

The likelihood that a segmented object 450 is an eye at X degrees is proportional to the feature space quadratic distance can be calculated by using the function Q. If Q is higher than a selected threshold, then the object is classified as an eye at X degrees, while if Q is lower than the given threshold, the object is classified as not an eye at X degrees. The threshold is set at a level that produces an acceptable compromise between false positives and false negatives. That is, the threshold is set at a level that enables an acceptably high proportion of eyes at X degrees to be detected, while minimizing the number of objects that are erroneously identified as eyes at X degrees. If an object is classified as a human eye in more than one direction, the final classification for that object will be a human eye in the direction for which the classifier had the highest Q. In this embodiment this classification step 416 produces four eye masks (0°, 90°, 180°, 270°(−90°).

Upon the classification step 412 being completed, method 400 then proceeds to step 414, where the image is resized. Multiple resolutions of the input image will be used in method 400. The input image is resampled to provide a half resolution image and a quarter resolution image respectively. A number of advantages result from conducting method 400 upon images of different resolutions. Specifically, for eyes that are above a certain size, such eyes can be efficiently identified through analysis of a quarter resolution image, rather than a half resolution image or a full resolution image, as (1) sufficient pixels showing the eyes are present, and (2) fewer pixels need be considered to find the eyes. However, with the smaller images (lower resolution images), information may not be contained in the lower resolution images that are required to identify the objects as eyes at a certain level of orientation as the required level of probability. Therefore, in such situations the full resolution image may provide more appropriate information that is used to classify objects as eyes, and at their appropriate orientation. Upon the images being resized method 400 is carried out on the resized input images as described above. Upon the resized images having the eye detection method 400 performed on them, there are potentially in this embodiment, 12 eye masks created, where small eyes will be determined from the quarter resolution images, and the method may then classify segmented objects which have been identified as eyes, in the quarter resolution image as small eyes at 0°, small eyes at 90°, small eyes at 180°, and small eyes at 270° (−90°). When the eye detection method 400 is performed on the medium sized image, the segmented objects that have been classified as eyes may be classified as medium eyes at 0°, 90°, 180°, 270° (−90°).

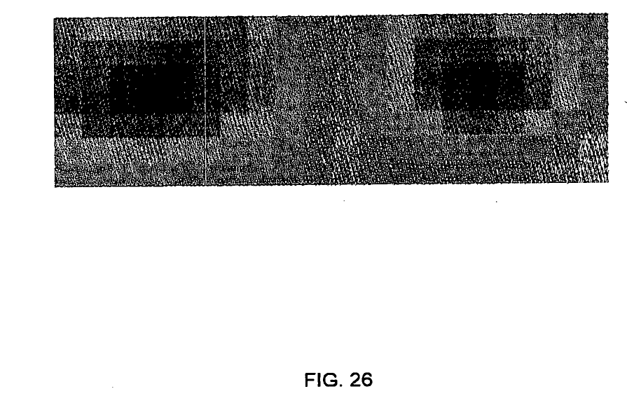

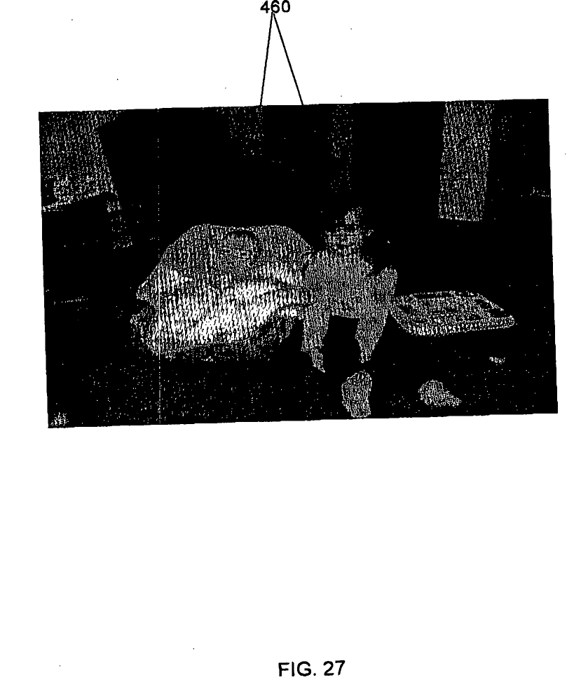

At step 216, the input image is analyzed for instances of the regions which would indicate upper areas of the human face. The presence of the human face in an image is detectible as it a distinctive facial feature, as other human facial regions such as the mouth are harder to recognize because of the various contortions of the mouth that may be captured in an image. Reference is made to FIG. 26, where a pixilated upper face pattern that highlights the location of the eyes in an image is shown. This pattern is generally discernable in most images, and as such detecting the upper face provides an accurate method by which information regarding image orientations may be obtained. The upper face will be detected by detecting the rectangular region that can be found from one eye to the other. Reference is made to FIG. 27 where an image is shown where rectangle regions 460 are highlighted.

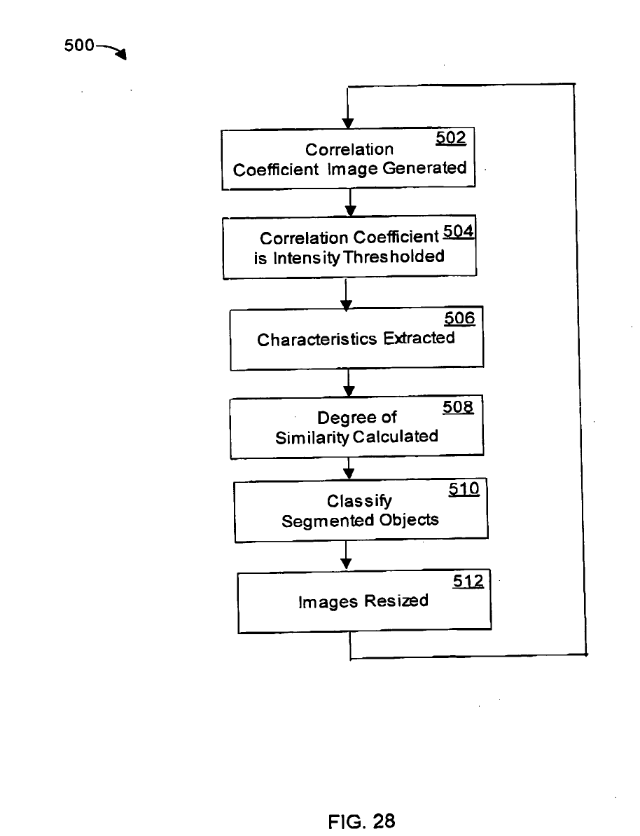

At step 216 an upper face detection algorithm is performed on the input image. The upper face detection algorithm performs upper face segmentation using at least one pattern match operation (using a pixel pattern for an upper human face like the pattern illustrated in FIG. 26). The upper face detection method 500 receives input from the flesh detection method as well as the input image and the component images generated at step 206. The upper face detection method 500 is described with reference to FIG. 28, where the steps of method 500 are shown. Method 500 begins at step 502 where a pattern match operation is performed on the green component image that was generated at step 204. The pattern match operation is performed by generating a correlation coefficient image C(s,t). The correlation coefficient image C(s,t) is defined as follows (“Digital Image Processing” by Rafael C. Gonzalez and Richard E. Woods, Addison Wesley Publishing, 1992 edition):

$$C ( s , t ) = \frac{( {\sum }_{x , y} [ f ( x , y ) - f\_mean ( x , y ) ] [ w ( x - s , y - t ) - w\_mean ] )}{{( {\sum }_{x , y} {[ f ( x , y ) - f\_mean ( x , y ) ]}^{2} {\sum }_{x , y} {[ w ( x - s , y - t ) - w\_mean ]}^{2} )}^{1 / 2}}$$

In the correlation coefficient image, f is the input image with dimensions M×N, w is the pixel pattern that will define the triangle region 460, that is being searched for of size J×K (where J≦M and K≦N), s=0, 1, 2, . . . M−1, t=0, 1, 2, . . . N−1, w_mean is the average value of the pixels in w (computed only once), f_mean is the average value of f in the region coincident with the current location of w, and the summations are taken over the coordinates common to both f and w. C(s,t) is scaled from 1 to −1. A maximum value of C(s,t) indicates the position where w(x,y) best matches f(x,y), which indicates the similarity with the pattern that is being searched for. The correlation coefficient image will contain brighter regions which will generally correspond to regions with a pattern similar to the pixel pattern that would indicate a rectangular region 460 in the green component image. Other component images (i.e. red, and blue) may also be used to detect upper face regions.

Method 500 then proceeds to step 504 where the correlation coefficient image is intensity thresholded such that the bright regions may be analyzed further. The intensity thresholding results in the creation of a small segmented upper face mask, where the locations of the segmented objects are represented by white pixels and all other pixels will be black. A single segmented object is defined as a collection of white pixels adjacent to one another (vertically, diagonally or horizontally). These objects are then enlarged proportionally to the size of the pixel pattern w, so that the characteristics that are extracted contain more information so that appropriate determinations may be made. The flesh mask generated by the flesh detection method is dilated and enlarged, and this is then combined (through use of a logical AND operation) with upper face like regions that are identified so that only upper face like patterns of human flesh color are retained to create a small segmented upper face mask.

Method 500 then proceeds to step 506 where the characteristics from the small segmented upper face mask created at step 504 are extracted. The segmented objects have their characteristics extracted which may include the original color of each segmented object, and its original color texture as well as the original color and texture of the region surrounding the object. The color features which may be extracted may include the mean red intensity of the object, the maximum red intensity within the object, and the mean green intensity of the object. The texture characteristics may be calculated by measuring the pixel intensities in the object after an edge filter has been applied to the image generated at step 504.

Each object that has been segmented at step 504 will be classified based on the likelihood that the object is one of the following: an upper human face at 0°, an upper human face at 90°, an upper human face at 180°, an upper human face at 270°(−90°), or not an upper human face. Method 500 then proceeds to step 508 where the degree of similarity between the segmented objects from step 504 and upper face feature template at an X degree paradigm cluster is determined. This likelihood can be determined by calculating segmented object's feature space quadratic distance to a training upper human face (template) at X degrees feature cluster (can we have more information about this feature cluster). The equation for the quadratic classifier distance (Q) is the same equation that has been described above.

The likelihood that a segmented object is an upper human face at X degrees is proportional to the feature space quadratic distance can be calculated using Q. A threshold value is set, where if Q is higher than a selected threshold, then the object is classified as an upper human face at X degrees, while if Q is lower than the given threshold, the object is classified as not an upper human face at X degrees. The threshold is set such that it produces an acceptable compromise between false positives and false negatives, which allows for high proportion of upper human faces at X degrees to be detected, while the number of objects that are erroneously identified as an upper human face at X degrees are minimized.

Method 500 then proceeds to step 512. At step 512, the image is resized (increase or decrease in resolution). In one embodiment of the invention, the upper face detection method 500 is carried out on three resolutions of the image, a full size resolution (the size of the input image that was input), a half size resolution and a quarter size resolution. Method 500 is carried out on the resized images.

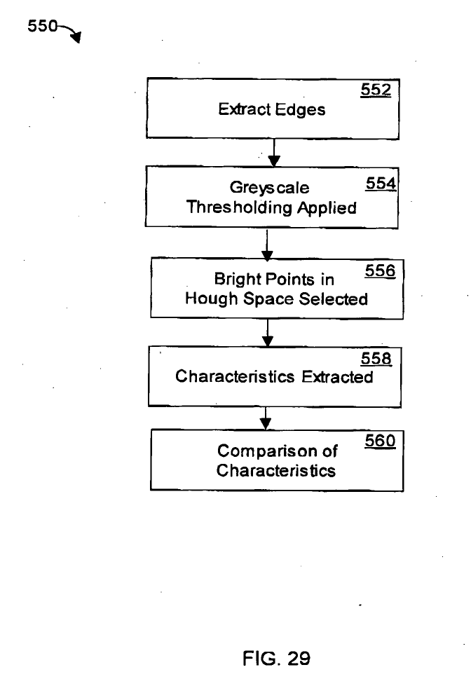

At step 220, a straight line detection algorithm is performed. If an image indicates the presence of a straight line, this information may be used in classifying the image. Reference is made to FIG. 29 where the steps of a straight line detection method 550 are shown. Method 550 begins at step 552 where edges are extracted from a greyscale image, which in this embodiment is the intensity image that that has been created at step 204. Edges may be extracted by convolving the intensity image with one or more edge kernels. Edge kernels which may be used include horizontal edge kernels, vertical edge kernels, and Laplacian edge kernels. These respective edge kernels may be represented as follows:

Horizontal Edge Kernel

| | | |
|---|---|---|
| 2 | 2 | 2 |
| 0 | 0 | 0 |
| −2 | −2 | −2 |

Vertical Edge Kernel

| | | |
|---|---|---|
| −2 | 0 | 2 |
| −2 | 0 | 2 |
| −2 | 0 | 2 |

Laplacian Edge Kernel

| | | |
|---|---|---|
| −1 | −1 | −1 |
| −1 | 8 | −1 |
| −1 | −1 | −1 |

The result of image convolution with an edge kernel highlights regions in the image that undergo rapid intensity change. Vertical edge kernels are used to detect vertical edge lines and horizontal edge kernels are used to detect horizontal edge lines. By convolving the intensity image with the appropriate edge kernel, an edge image is produced. Method 550 then proceeds to step 554 where a greyscale thresholding operation is applied to the edge image to produce a binary edge image. The greyscale thresholding operation results in the identification of the pixels that are of most interest in an attempt to detect straight lines. A Hough transform function is applied to the binary edge image to locate pixels that are found in a straight line pattern. The following transform (as defined in “Digital Image Processing” by Rafael C. Gonzalez and Richard E. Woods, Addison Wesley Publishing, 1992 edition), is used to map pixels of interest from the binary edge image in Cartesian space [x,y] to Hough space [[ρ, θ] using the normal representation of a line:
x cos θ+y sin θ=ρ
where
θ=the angle of a line in Cartesian space measured with respect to the positive x axis, and
ρ=the perpendicular distance from the Cartesian origin to the line.

Upon the application of the Hough transform, brighter regions may be located in the Hough space, which represent occurrences of straight lines in the Cartesian space. Method 550 then proceeds to step 556 where the brightest points in the Hough space are selected, and are mapped back to the Cartesian space using the transform that has been described above. At the conclusion of step 556, an image is created that represents the straight line regions that are found within the original input image.

Method 550 then proceeds to step 558, where the characteristics of the straight lines that have been identified are extracted. Straight line characteristics which may be extracted include, but are not limited to the slope of the lines, the length of the lines, the intersection points and the convergence points. These characteristics provide information that will be used by the classifier 224 to make a final determination as to image orientation.

At step 224, a final classifier method is performed. The final classifier method receives input from the detection methods that have been run at steps 208, 210, 212, 214, 215, 216, 218, and 220. The final classifier method takes input from a plurality of the detection algorithms and determines a final orientation of the image. The classifier has a feature classification order that it makes use of when determining which detection methods are to be run in order to provide information to the classifier when determining a final image orientation. The classifier and the feature classification order may specify that particular methods are to be run, and that other methods are to be run only when required. The classifier controls the operation of the image orientation method 200 and determines the sequencing associated with the execution of the respective methods.

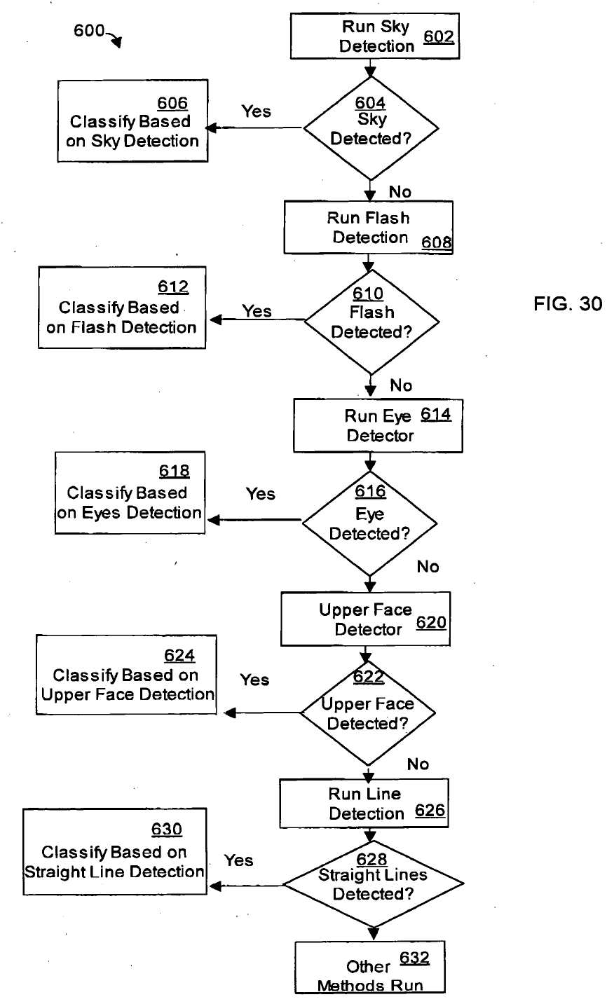

Reference is made to FIG. 30 where one embodiment of the implementation of the final classifier method 600 is shown. Method 600 begins with step 602 where the feature classification order in this embodiment has specified that the sky detection method 300 is to be executed at step 208. The details of the operation of the sky detection method 300 have been discussed above. Upon the execution of the sky detection method 300, method 600 then proceeds to step 604 where a check is performed to determine whether any elements of the sky were located in the image. If at step 604 it is determined that elements of the sky have been located in the image, method 600 proceeds to step 606. At step 606, method 600 attempts to determine a classification of the image as to its orientation. Output from step 213 is used by the classifier method 600. The classification step 606 used the output of step 213 to determine where the image that contains sky elements as has been determined above, is an image containing sky features at 0°, 90°, 180°, or 270°. At step 606 the determination as to whether the image is at one of the above mentioned orientations is determined by calculating the similarity between global image characteristics (the output of the global characteristics extraction method at step 213) and image paradigm clusters, as referred to as feature templates for each possible orientation. The image is then classified as having the orientation to the image paradigm to which it is most similar. The degrees of similarity may be measured by calculating the feature space quadratic distance (Q) to a training image feature classifier. Depending on the degrees of similarity as determined for all four orientations, the orientation which has the highest degree of similarity will be the orientation the image is classified as.

If at step 604 sky elements are not detected, method 600 then proceeds to step 608 where the flash detection method 215 is run to determine if the occurrence of a flash has been determined. Method 600 then proceeds to step 610 where a check is performed to determine whether the occurrence of a flash can be determined in the image. If at step 610 it is determined that the occurrence of the flash has occurred in the image, method 600 proceeds to step 612. At step 612 it is determined what orientation the image is taken at. At step 612 the determination as to what orientation the image is at, is determined by calculating the similarity between elements of the image and image paradigm clusters, referred to as feature templates for each possible orientation. The image is then classified as having the orientation of the image paradigm to which it is most similar. The degrees of similarity may be measured by calculating the feature space quadratic distance (Q) to a training image feature classifier. Depending on the degrees of similarity as determined for all four orientations, the orientation which has the highest degree of similarity will be the orientation the image is classified as.

If at step 610, it is determined that the flash is not detected, method 600 proceeds to step 614, where the eye detection method 400 is performed. The eye detection method 400 is used to determine the presence of a human or animal eye, information which is then used to determine the orientation of the eye. Method 600 then proceeds to step 616 where a check is performed to determine if eyes have been located in the image. If eyes have been located in the image, method 600 proceeds to step 618, where the orientation of the image is classified based on the eye masks that were created and global image characteristics from step 213. The classification step 618 makes use of the orientation of the eyes as has been determined in method 400 along with information with respect to the location of the eyes from the eye masks to attempt to determine an orientation of the image. At step 618 the determination as to what orientation the image is at, is determined by calculating the similarity between elements of the image and image paradigm clusters, as referred to as feature templates for each possible orientation. The image is then classified as having the orientation of the image paradigm to which it is most similar. The degrees of similarity may be measured by calculating the feature space quadratic distance (Q) to a training image feature classifier. Depending on the degrees of similarity as determined for all four orientations, the orientation which has the highest degree of similarity will be the orientation the image is classified as.

If at step 616, it is determined that one or more eyes have not been detected, method 600 proceeds to step 620, where the upper face detection method 500 is used. Method 600 then proceeds to step 622 where a check is performed to determine whether the occurrence of an upper face was detected. If the occurrence of the upper face was determined to have occurred at step 622, method 600 proceeds to step 624 where the orientation of the image is determined. The orientation of the upper faces along with their locations as determined from the upper face masks and global image characteristics from step 213 are used to determine the orientation of the image. At step 618 the determination as to what orientation the image is at, is determined by calculating the similarity between elements of the image and image paradigm clusters, as referred to as feature templates for each possible orientation. The image is then classified as having the orientation of the image paradigm to which it is most similar. The degrees of similarity may be measured by calculating the feature space quadratic distance (Q) to a training image feature classifier. Depending on the degrees of similarity as determined for all four orientations, the orientation which has the highest degree of similarity will be the orientation the image is classified as.

If the check performed at step 622 reveals that the instance of the upper face was not detected, method 600 then proceeds to step 626 where the straight line detection method 550 is performed. The straight line detection method 550 as discussed above operates on an image to determine the presence of straight lines, characteristics of which are then used as well as global image characteristics from step 213 to determine the orientation of the image. Method 600 then proceeds to step 628 where a check is performed to determine whether straight lines were found in the image. If at step 628 it is determined that straight lines were found in the image, method 600 proceeds to step 630 where the orientation of the image is classified based on the straight line characteristics that were extracted. If the occurrence of the straight lines was determined to have occurred at step 626, method 600 proceeds to step 630 where the orientation of the image is determined. At step 630 the determination as to the orientation of the image is determined by calculating the similarity between elements of the image and image paradigm clusters, referred to as feature templates, that have been specified for images that contain lines, for each possible orientation. The image is then classified as having the orientation of the image paradigm to which it is most similar. The degrees of similarity may be measured by calculating the feature space quadratic distance (Q) to a training image feature classifier. Depending on the degrees of similarity as determined for all four orientations, the orientation which has the highest degree of similarity will be the orientation the image is classified as.

If at step 628 it is determined that no instances of straight lines were found in the image, method 600 then proceeds to step 632, where other methods such as the foliage detection method, or flesh detection method may be run to determine the orientation of the image. At step 632 other algorithms may be used that make use of the global image characteristics from step 213 in order to attempt to determine an image orientation.

Method 600 has been described with respect to one possible feature classification order. Optionally, however many feature classification orders may be used. Further, in some embodiments a user may specify their own feature classification order. Also, the classifications performed as a result of more than one method may be used in the final classifier method 600

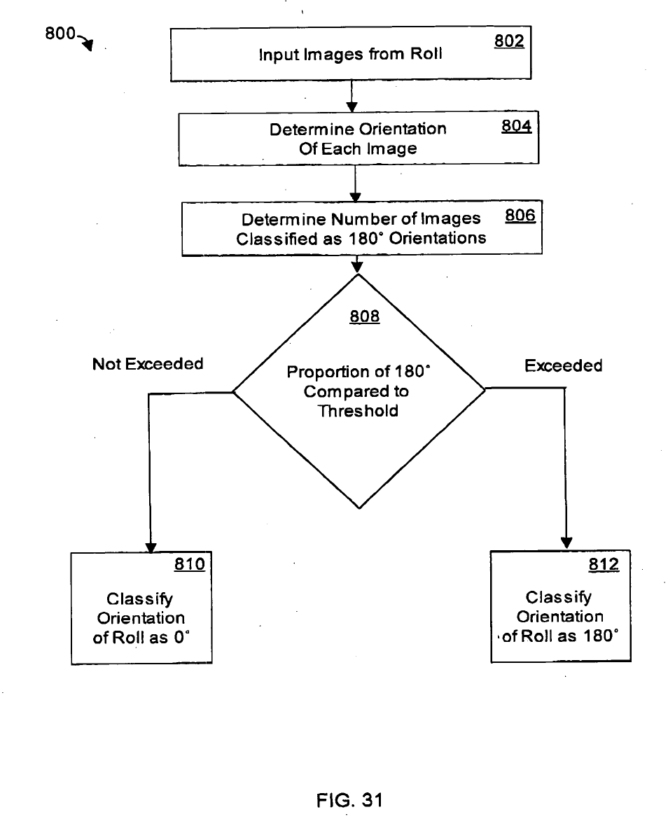

Reference is made to FIG. 31, where the steps of a film roll orientation method 800 are shown. The film roll orientation method 800 is used to detect the orientation of images on a film roll in an attempt to classify the overall orientation of images on the film roll. Cameras such as single lens reflex (SLR) cameras produce images that are upside down on film relative to non SLR cameras, and thus these images have been rotated 180° when they are stored on digital storage mediums. Therefore, orientation method 800 can be used to determine the correct orientation of the image set associated with the film roll by analyzing the images in the image set.

Method 800 begins at step 802 where the images are input from the film roll to an appropriate system, such as the computer system 10 that has been described above. Method 800 then proceeds to step 804, where for each image that is associated with the film roll, the orientation of each is determined through the orientation detection method and classifier method as have been described above. Method 800 then proceeds to step 806 where the number of images that have been classified as being at an orientation of 180° are determined. Method 800 then proceeds to step 808 where a check is performed to determine whether the proportion of images in the film roll that are classified as 180° exceed a threshold value that has been established. The threshold value is established based on determining a value that would achieve the highest rate of correct classification of image rolls. The threshold value is determined based on statistical analysis of the image orientation associated with other film rolls, and as such is chosen to maximize accurate results. Method 800 then proceeds to step 810 if it is determined that the proportion does not exceed the threshold value, and the orientation of the roll is determined to be 0° (i.e. it is in its correct orientation). If at step 808 it is determined that the proportion exceeds the threshold value, then the orientation of the roll is determined to be 180° (i.e. the images are upside down).

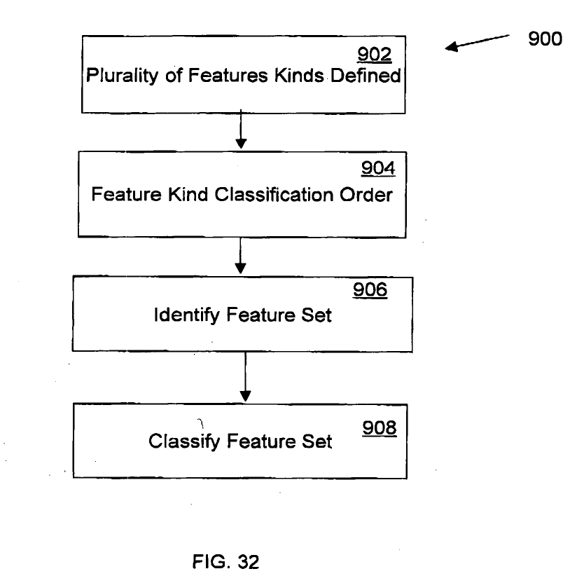

Referring to FIG. 32, there is illustrated in a flow chart a method of identifying an orientation of an image in accordance with some aspects of the present invention as is described with reference to method 900. The image comprises a plurality of features, such as, for example, bits of sky, evidence of flash, pairs of eyes, etc. At step 902, a plurality of feature kinds are defined. This plurality of feature kinds corresponds to the plurality of features found within the image, although it may, and often will, comprise additional feature kinds. For example, a particular image may have pairs of eyes, and evidence of a flash, but not have bits of sky, or straight lines, while the feature kinds defined would include straight lines and sky, as well as pairs of eyes and evidence of flash. In step 904, a feature kind classification order is provided for ordering all of the feature kinds. That is, some feature kinds may be more useful in determining an orientation than other feature kinds. As shown in FIG. 30, according to some aspects of the invention, a possible feature kind classification order is as follows: (1) sky, (2) evidence of flash, (3) eye pairs, (4) upper face and (5) straight lines. However, other feature kind classification orders may be used depending on desired outcomes, and the images being dealt with. For example, in the case of a collection of photographs all of which were taken indoors, sky may be moved down the feature kind classification order to be below evidence of flash, eye pairs, upper face and straight lines, or may even be removed entirely

In step 906, the method searches the image to identify a feature set comprising at least one feature in the plurality of features in the image. The feature set determined in step 906 is determined, at least in part, based on the feature kind classification order. Each of the features in the feature set corresponds to a defining feature kind.

For example, consider a case in which an image includes bits of sky, as well as pairs of eyes. In step 906 the method will identify at least one piece of sky—the at least one feature in the feature set. Then, in step 908, the method will classify this feature set to determine the orientation of the image. In some embodiments, the method will not classify the pairs of eyes also found in the image to determine the orientation of the image as eyes are listed lower in the feature kind classification order of FIG. 28 than sky. In some embodiments, the classification of the orientation of the image in step 908 is then determined based on information stored regarding various sky orientations.

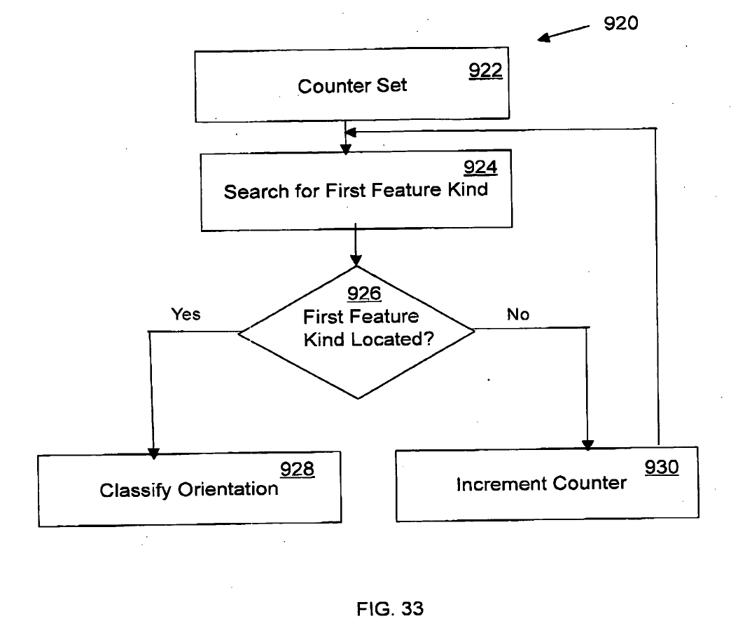

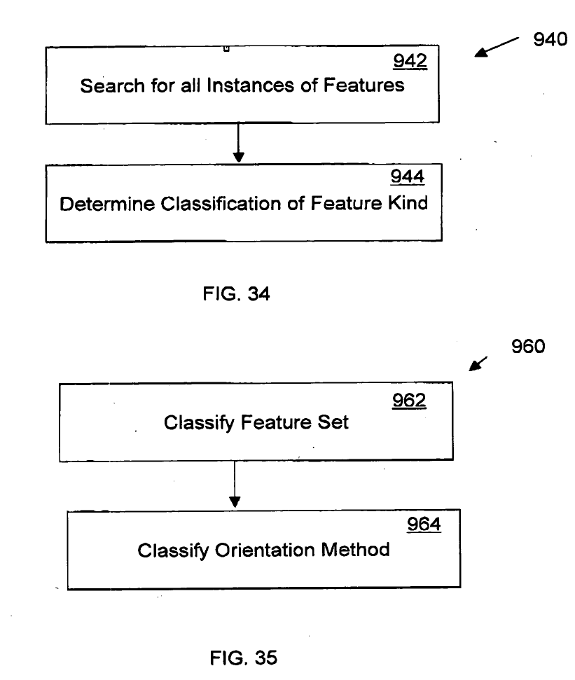

Step 906 of the method of FIG. 32 may be implemented in different ways. Two different ways of implementing step 906 are illustrated in more detail in FIGS. 33 and 34. Referring to FIG. 33, there is illustrated in a flow chart a method of searching the image based on the feature kind classification order as shown in method 920. That is, in step 922, a counter k is set equal to 1. Then the method proceeds to method 924, in which, on this iteration, the method of FIG. 33 searches in the image for a feature of the first feature kind listed in the feature kind classification order. That is, in the case of the feature kind classification order illustrated in FIG. 28, the method will first search for instances of sky within the image. After the image has been searched for instances of sky, the method proceeds to query 926, which returns the answer YES if instances of sky are found in the image, in which case, in step 928, the method returns to step 908 of the method of FIG. 32 to classify the orientation of the image based on the instances of sky found in the image. However, if no instances of sky were found in step 924, then query 926 will return the answer NO, and the method will proceed to step 930, in which the counter k is incremented by 1, before the method once again returns to step 924 for a second iteration. Based on the feature kind classification order illustrated in FIG. 28, the method would be looking for evidence of flash in this second search through the image. According to the variant of step 906 illustrated in FIG. 33, once the method finds the at least one first feature, the method will no longer look for other features. Instead, the orientation of the image will be classified based on this at least one first feature. According to other aspects of the invention, the image may be searched for features corresponding to all of the different features before the classification step. Variants of these aspects of the present invention are illustrated below in FIG. 34.

Referring to FIG. 34, there is illustrated in a flow chart a method of implementing step 906 of FIG. 32 as described in method 940. In step 942 of FIG. 34, the method searches the image for instances of all of the feature kinds to identify all of the features in the image. For example, say that in a particular image, there are instances of sky, evidence of flash, pairs of eyes, and upper faces showing. Then, according to the aspects of the invention illustrated in FIG. 34, these individual instances of sky, flash, pairs of eyes, and upper faces would be searched for and identified in step 942. Then, in step 944, the method would determine which feature kind, corresponding to a feature actually identified within the image, is listed highest in the feature kind classification order. In the present example, this would be the instance of sky. Then, the method would return to step 928 of FIG. 32 to classify the orientation of the image.

Referring to FIG. 35, step 908 of the method of FIG. 32 is illustrated in more detail at method 960. Recall that in step 908, the orientation of an image is classified based on the feature set and the at least one feature it contains.

Recall that the image database 124 described above includes images stored at different orientations—specifically 0°, 90°, 180° or 270°. Optionally, of course, images may also be stored at other orientations, which orientations are themselves recorded. As a result, this image database provides a feature template for each of the feature kinds. Further, each of these feature templates comprises a cluster of image paradigms (as referred to as feature records), with each image paradigm corresponding to a stored orientation. For example, the image database 124 can include multiple pictures of people, having upper faces and pairs of eyes. These images would be stored at different orientations, thereby providing feature templates for both pairs of eyes and upper faces.

At step 962 of FIG. 35, the determination as to what orientation the image is at, is determined by calculating the similarity between elements of the image and the image paradigm clusters (as referred to as feature templates). The image is then classified at step 964 as having the orientation of the image paradigm to which it is most similar. The degrees of similarity may be measured by calculating the feature space quadratic distance (Q) to a training image feature classifier. Depending on the degrees of similarity as determined for all four orientations, the orientation which has the highest degree of similarity will be the orientation the image is classified as.

Other variations and modifications of the invention are possible. For example, while the foregoing has been described in the context of a red-green-blue pixel coloring system, other color systems could be used, such as, for example, a cyan-magenta-yellow key system or a hue-saturation-value system, which similarly represents colors as combinations of their respective color components. All such modifications or variations are believed to be within the shape and scope of the invention as defined by the claims appended hereto.

1. A method of identifying an orientation of an image having a plurality of features, the method comprising:
a) defining a plurality of feature kinds, wherein each feature in the plurality of features corresponds to an associated feature kind in the plurality of feature kinds;
b) providing a feature kind classification order for ordering the plurality of feature kinds;
c) searching the image to identify a feature set in the plurality of features in the image based on the feature kind classification order, wherein the feature set comprises at least one feature and each feature in the feature set corresponds to a defining feature kind; and
d) classifying the feature set to determine the orientation of the image.

2. The method as defined in claim 1 wherein step d) comprises classifying the image based on the defining feature kind to determine the orientation of the image.

3. The method as defined in claim 1 wherein, when the plurality of features comprises, in addition to the feature set, at least one remaining feature corresponding to at least one associated feature kind different from the defining feature kind for each feature in the feature set,
the associated defining feature kind for the feature set precedes each of the at least one associated feature kind in the feature kind classification order.

4. The method as defined in claim 3 wherein step c) comprises searching the image for each feature kind in the plurality of feature kinds based on the feature kind classification order until the feature set is identified and then ceasing searching.

5. The method as defined in claim 3 wherein step c) comprises i) searching the image to identify the plurality of features in the image, and then ii) determining the feature set in the plurality of features based on the feature kind classification order.

6. The method as defined in claim 3 further comprising providing a plurality of feature templates corresponding to the plurality of feature kinds in the image, wherein step d) comprises classifying the image based on a feature template in the plurality of feature templates corresponding to the feature set.

7. The method as defined in claim 6 wherein, for each feature kind in the plurality of feature kinds, the corresponding feature template comprises a plurality of feature records at a plurality of stored orientations, each feature record corresponding to a stored orientation.

8. The method as defined in claim 7 wherein step d) comprises
classifying the image to determine the orientation of the image by comparing the image to the plurality of feature records in the corresponding feature template to determine a closest feature record in the plurality of feature records; and,
determining the orientation of the image to be a stored orientation for a closest feature record.

9. The method as defined in claim 1 wherein step c) comprises resizing the image before searching the image to identify the feature set.

10. The method as defined in claim 1 wherein the plurality of feature kinds comprises at least two of i) a sky kind, ii) a flash kind, iii) an eye kind, iv) an upper face kind and v) a line kind.

11. A system for identifying an orientation of an image having a plurality of features, the system comprising:
a memory for storing (i) the image; and (ii) a plurality of feature kinds, wherein each feature in the plurality of features corresponds to an associated feature kind in the plurality of feature kinds;
means for performing the steps of
a) accessing a feature kind classification order for ordering the plurality of feature kinds;
b) searching the image to identify a feature set in the plurality of features in the image based on the feature kind classification order, wherein the feature set comprises at least one feature and each feature in the feature set corresponds to a defining feature kind; and
c) classifying the feature set to determine the orientation of the image.

12. The system as defined in claim 11 wherein step c) comprises classifying the image based on the defining feature kind to determine the orientation of the image.

13. The system as defined in claim 11, wherein, when the plurality of features comprises, in addition to the feature set, at least one remaining feature corresponding to at least one associated feature kind different from the defining feature kind for each feature in the feature set,
the associated defining feature kind for the feature set precedes each of the at least one associated feature kind in the feature kind classification order.

14. The system as defined in claim 13 wherein step b) comprises searching the image for each feature kind in the plurality of feature kinds based on the feature kind classification order until the feature set is identified and then ceasing searching.

15. The system as defined in claim 13 wherein step b) comprises i) searching the image to identify the plurality of features in the image, and then ii) determining the feature set in the plurality of features based on the feature kind classification order.

16. The system as defined in claim 13 further comprising providing a plurality of feature templates corresponding to the plurality of feature kinds in the image stored on the memory, wherein step c) comprises classifying the image based on a feature template in the plurality of feature templates corresponding to the feature set.

17. The system as defined in claim 16 wherein, for each feature kind in the plurality of feature kinds, the corresponding feature template comprises a plurality of feature records at a plurality of stored orientations, each feature record corresponding to a stored orientation.

18. The system as defined in claim 17 wherein step c) comprises
classifying the image to determine the orientation of the image by comparing the image to the plurality of feature records in the corresponding feature template to determine a closest feature record in the plurality of feature records; and,
determining the orientation of the image to be a stored orientation for a closest feature record.

19. The system as defined in claim 11 wherein step b) comprises resizing the image before searching the image to identify the feature set.

20. The system as defined in claim 11 wherein the plurality of feature kinds comprises at least two of i) a sky kind, ii) a flash kind, iii) an eye kind, iv) an upper face kind and v) a line kind.

21. The system as defined in claim 11, further comprising
a display for displaying one or more images; and
input means for selecting an image for which an orientation is identified.

22. A computer program product for use on a computer system for identifying an orientation of an image having a plurality of features, the computer program product comprising:
a recording medium for recording (i) a plurality of feature kinds, wherein each feature in the plurality of features corresponds to an associated feature kind in the plurality of feature kinds; and (ii) means for instructing the computer system to perform the steps of:
a) accessing a feature kind classification order for ordering the plurality of feature kinds;
b) searching the image to identify a feature set in the plurality of features in the image based on the feature kind classification order, wherein the feature set comprises at least one feature and each feature in the feature set corresponds to a defining feature kind; and
c) classifying the feature set to determine the orientation of the image.

23. The computer program product as defined in claim 22 wherein step c) comprises classifying the image based on the defining feature kind to determine the orientation of the image.

24. The computer program product as defined in claim 22, wherein, when the plurality of features comprises, in addition to the feature set, at least one remaining feature corresponding to at least one associated feature kind different from the defining feature kind for each feature in the feature set,
the associated defining feature kind for the feature set precedes each of the at least one associated feature kind in the feature kind classification order.

25. The computer program product as defined in claim 24 wherein step b) comprises searching the image for each feature kind in the plurality of feature kinds based on the feature kind classification order until the feature set is identified and then ceasing searching.

26. The computer program product as defined in claim 24 wherein step b) comprises i) searching the image to identify the plurality of features in the image, and then ii) determining the feature set in the plurality of features based on the feature kind classification order.

27. The computer program product as defined in claim 24 further comprising providing a plurality of feature templates corresponding to the plurality of feature kinds in the image, wherein step c) comprises classifying the image based on a feature template in the plurality of feature templates corresponding to the feature set.

28. The computer program product as defined in claim 27 wherein, for each feature kind in the plurality of feature kinds, the corresponding feature template comprises a plurality of feature records at a plurality of stored orientations, each feature record corresponding to a stored orientation.

29. The computer program product as defined in claim 28 wherein step c) comprises
classifying the image to determine the orientation of the image by comparing the image to the plurality of feature records in the corresponding feature template to determine a closest feature record in the plurality of feature records; and,
determining the orientation of the image to be a stored orientation for a closest feature record.

30. The computer program product as defined in claim 22 wherein step b) comprises resizing the image before searching the image to identify the feature set.

31. The computer program product as defined in claim 22 wherein the plurality of feature kinds comprises at least two of i) a sky kind, ii) a flash kind, iii) an eye kind, iv) an upper face kind and v) a line kind.
